(19) United States
(12) Patent Application Publication
(10) Pub. No.: US 2026/0173178 A1
(43) Pub. Date: Jun. 18, 2026

(54) PROFILE BASED LAYER-2 TUNNELING OF NETWORK TRAFFIC

(71) Applicant: Cisco Technology, Inc., San Jose, CA (US)

(72) Inventors: Bart Brinckman, Nevele (BE); Jerome Henry, Pittsboro, NC (US); Vincent Parla, North Hampton, NH (US)

(21) Appl. No.: 18/980,894

(22) Filed: Dec. 13, 2024

(51) Int. Cl. H04W 76/12; H04W 12/06; H04W 76/15

(52) U.S. Cl. CPC H04W 76/12; H04W 12/06; H04W 76/15

(57) ABSTRACT

Aspects of the present disclosure provide an endpoint configured with multiple profiles, a separate IP address to be used for transmission of respective traffic of each profile using a dedicated and automatically configured L2 tunnel. A method includes receiving an association request from the endpoint; authenticating the endpoint in association with the enterprise profile, using a first MAC address of the endpoint; receiving, as part of an authentication success message, at least a second MAC address of a tunnel endpoint and an IP address of a domain name of the tunnel endpoint; and providing a personal IP address and an enterprise IP address to the endpoint, wherein the access point establishes a personal L2 connection with the endpoint using the personal IP address for receiving personal traffic and an enterprise L2 connection with the endpoint using the enterprise IP address for receiving enterprise traffic.

### TECHNICAL FIELD

The present technology pertains to wireless communications, and more specifically, to separate layer-2 tunneling of different types of network traffic to and from devices connected to a wireless network.

### BACKGROUND

In enterprise networks, connected users often access professional resources (e.g., work e-mail, enterprise applications, etc.) as well as personal resources (e.g., personal banking, personal e-mail, streaming services such as YouTube at break times etc.) from devices assigned to the users by the enterprise (e.g., work-issued computers, tablets, phones, etc.). It is desirable to have personal traffic sent directly to the internet at the first internet peering point (e.g., at an access point to which a given device is connected), while corporate traffic is tunneled to a cloud security service such as a SASE service. This splitting of the may be is typically achieved by a Layer 3 tunnel from the connected device. Doing so requires manual L3 tunnel setup with split routing installed by the tunnel endpoint. Furthermore, such splitting cannot distinguish between work-related applications and personal application as split tunneling is performed based on routing installed by the tunneling.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example of a high-level network architecture according to some aspects of the present disclosure;

FIG. 2 illustrates an example network structure for performing Layer-2 split tunneling according to some aspects of the present disclosure;

FIG. 3 illustrates a method for performing Layer-2 split tunneling according to some aspects of the present disclosure; and

FIG. 4 shows an example of a system for implementing certain aspects of the present technology.

### DETAILED DESCRIPTION

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### OVERVIEW

Aspects of the present disclosure are directed to providing an endpoint configured with multiple profiles, a separate IP address to be used for transmission of respective traffic of each profile using a dedicated and automatically configured Layer-2 tunneling.

In one aspect, a method includes receiving a request from an endpoint to connect to the access point, wherein the endpoint is configured with at least a personal profile and an enterprise profile; authenticating the endpoint in association with the enterprise profile, using a first MAC address of the endpoint and against an enterprise identity and authorization service; receiving, as part of a message indicating successful authentication of the enterprise profile, at least a second MAC address of a tunnel endpoint and an IP address of a domain name of the tunnel endpoint; and upon completion of a handshake process between the endpoint and the access point, providing a personal IP address and an enterprise IP address to the endpoint, the enterprise IP address being the IP address of the domain name of the tunnel endpoint, wherein the access point establishes a personal L2 connection with the endpoint using the personal IP address and an enterprise L2 connection with the endpoint using the enterprise IP address. The access point transmits personal traffic received over the personal L2 connection directly to internet and forwards enterprise network traffic received over the enterprise L2 connection to the tunnel endpoint

In another aspect, the endpoint generates the first MAC address, and the first MAC address is a personal MAC address of the endpoint.

In another aspect, the access point authenticates the endpoint using a tunneled Extensible Authentication Protocol method.

In another aspect, the message is an Extensible Authentication Protocol success message and the second MAC address is included inside a TLS tunnel of the Extensible Authentication Protocol success message and is included outside the TLS tunnel of the Extensible Authentication Protocol success message along with the IP address of the tunnel endpoint.

In another aspect, providing the personal IP address includes receiving an indication from the endpoint that the endpoint has disassociated with the access point; receiving a request for a re-association from the endpoint with the first MAC address after it disassociated with the access point; completing the re-association using the first MAC address; and assigning the personal IP address to the endpoint after completing the re-association.

In another aspect, providing the enterprise IP address includes receiving an association request based on the second MAC address, wherein the second MAC address is provided to the endpoint as part of the message; sending the request encapsulated an L2 tunneling protocol to the tunnel endpoint; and upon a successful completion of a handshake between the endpoint and the tunnel endpoint, receiving the enterprise IP address from the tunnel endpoint to be provided to the endpoint.

In another aspect, the message includes at least a third MAC address of a second tunnel endpoint and a second IP address of a second domain name for the second tunnel endpoint; and the access point establishes a second enterprise L2 connection, wherein at least a portion of the enterprise network traffic is sent over the enterprise L2 connection and another portion of the enterprise network traffic is sent over the second enterprise L2 connection.

In one aspect, an access point includes one or more memories having computer-readable instructions stored therein; and one or more processors. The one or more processors are configured to execute the computer-readable instructions to receive a request from an endpoint to connect to the access point, wherein the endpoint is configured with at least a personal profile and an enterprise profile; authenticate the endpoint in association with the enterprise profile, using a first MAC address of the endpoint and against an enterprise identity and authorization service; receive, as part of a message indicating successful authentication of the enterprise profile, at least a second MAC address of a tunnel endpoint and an IP address of a domain name of the tunnel endpoint; and upon completion of a handshake process between the endpoint and the access point, provide a personal IP address and an enterprise IP address to the endpoint, the enterprise IP address being the IP address of the domain name of the tunnel endpoint, wherein the access point establishes a personal L2 connection with the endpoint using the personal IP address and an enterprise L2 connection with the endpoint using the enterprise IP address. The access point transmits personal traffic received over the personal L2 connection directly to internet and forwards enterprise network traffic received over the enterprise L2 connection to the tunnel endpoint.

In one aspect, one or more non-transitory computer-readable media include computer-readable instructions, which when executed by one or more processors of an access point, cause the access point to receive a request from an endpoint to connect to the access point, wherein the endpoint is configured with at least a personal profile and an enterprise profile; authenticate the endpoint in association with the enterprise profile, using a first MAC address of the endpoint and against an enterprise identity and authorization service; receive, as part of a message indicating successful authentication of the enterprise profile, at least a second MAC address of a tunnel endpoint and an IP address of a domain name of the tunnel endpoint; and upon completion of a handshake process between the endpoint and the access point, provide a personal IP address and an enterprise IP address to the endpoint, the enterprise IP address being the IP address of the domain name of the tunnel endpoint. Wherein the access point establishes a personal L2 connection with the endpoint using the personal IP address and an enterprise L2 connection with the endpoint using the enterprise IP address. The access point transmits personal traffic received over the personal L2 connection directly to internet and forwards enterprise network traffic received over the enterprise L2 connection to the tunnel endpoint.

### EXAMPLE EMBODIMENTS

As noted above, splitting personal and professional traffic when accessed on the same device is often carried out via manual Layer-3 tunnel splitting, which is not capable of distinguishing between personal and enterprise-specific (work-specific) applications (profile-based distinction).

As an example, consider an example where a user has an enterprise-issued device (work-issued device such as a laptop, a tablet, mobile phone, etc.). The device may be configured with a personal profile for the user as well as a work profile. As an example, the user may swipe to the work profile and open applications such as outlook, Webex, etc. Similarly, the user may swipe to personal profile and open personal applications such as personal banking application, etc. Currently, both profiles' traffic is treated the same (sent from the device to the on-site access point if the user is present at a location of the enterprise (e.g., in the office), or to an access point on another network outside the enterprise (e.g., an access point at a hotel or a publicly available Wi-Fi)). With the development of more stringent privacy laws around the world, this scheme will soon seize to be acceptable. The enterprise has no business observing the user’s personal banking traffic (e.g., when all traffic goes through an on-site access point). Yet there is no mechanism to push the personal traffic to a guest SSID (the access point has no mechanism to distinguish the personal traffic from the work traffic). As another example, while connected to an access appoint outside of the enterprise such as a hotel, the enterprise may have subscription to a premium Wi-Fi access at the hotel (e.g., to provide employees with reliable connectivity for work-related applications such as Webex). However, the enterprise may not want to pay for the employee to use such premium service for personal use such as accessing a streaming service. However, the access point at the hotel has no way to differentiate between the personal traffic and the work traffic. If the hotel access point observes some VPN traffic from the user device, the access point has no information on whether the incoming traffic is work traffic or personal traffic, hence no ability to apply any special treatment.

To address the deficiencies described above, aspects of the present disclosure are directed to split tunneling based on private or work profile on the device, as well as perform the tunneling automatically by setting up 2 separate Layer-2 (L2) contexts for private profiles and work profiles.

Thus what we are seeking a method to differentiate traffic from both profiles right from the access, in an anticipation of these upcoming stricter privacy laws. If successful, our goal (with Samsung) is to be first to market with privacy-preserving enterprise SSIDs, and also differentiating (basic access, premium access) Guest SSIDs.

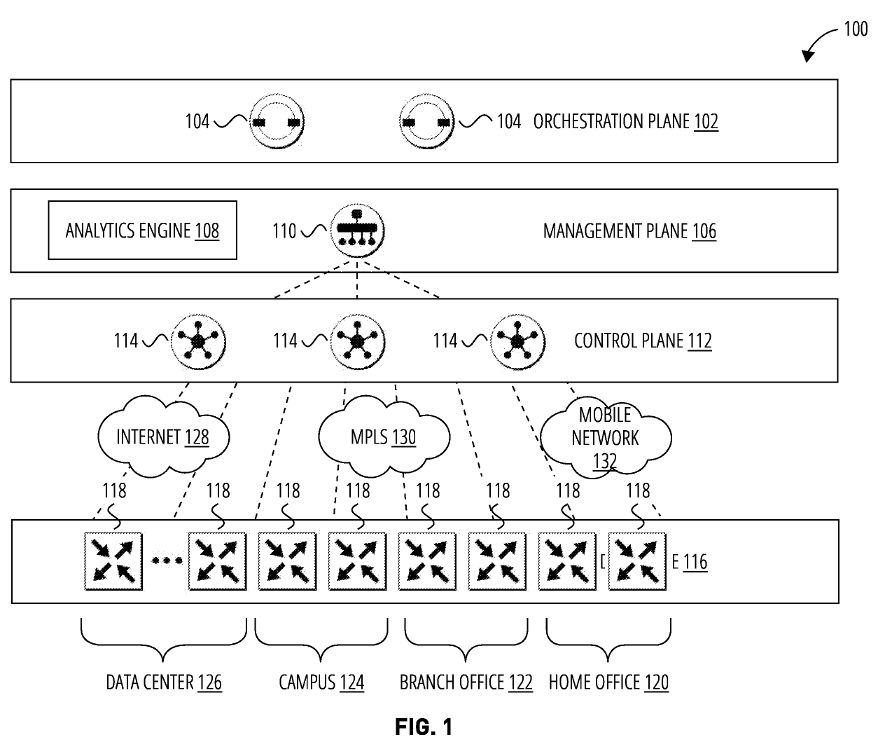

FIG. 1 illustrates an example of a network architecture 100 for implementing aspects of the present technology. An example of an implementation of the network architecture 100 is the Cisco® SD-WAN architecture. However, one of ordinary skill in the art will understand that, for the network architecture 100 and any other system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

In this example, the network architecture 100 can comprise an orchestration plane 102, a management plane 106, a control plane 112, and a data plane 116. The orchestration plane 102 can assist in the automatic on-boarding of edge network devices 118 (e.g., switches, routers, etc.) in an overlay network. The orchestration plane 102 can include one or more physical or virtual network orchestrators such as the network orchestrator appliances 104. The network orchestrator appliances 104 can perform the initial authentication of the edge network devices 118 and orchestrate connectivity between devices of the control plane 112 and the data plane 116. In some embodiments, the network orchestrator appliances 104 can also enable communication of devices located behind Network Address Translation (NAT). In some embodiments, physical or virtual Cisco® SD-WAN vBond appliances can operate as the network orchestrator appliances 104.

The management plane 106 can be responsible for central configuration and monitoring of a network. The management plane 106 can include an analytics engine 108 and one or more physical or virtual network management appliances such as the network management appliances 110. In some embodiments, the network management appliances 110 can provide centralized management of the network via a graphical user interface to enable a user to monitor, configure, and maintain the edge network devices 118 and links (e.g., internet transport network 128, MPLS network 130, 4G/Mobile network 132) in an underlay and overlay network. The network management appliances 110 can support multi-tenancy and enable centralized management of logically isolated networks associated with different entities (e.g., enterprises, divisions within enterprises, groups within divisions, etc.). Alternatively or in addition, the network management appliances 110 can be a dedicated network management system for a single entity. In some embodiments, physical or virtual Cisco® SD-WAN vManage appliances can operate as the network management appliances 110.

The control plane 112 can build and maintain a network topology and make decisions on where traffic flows. The control plane 112 can include one or more physical or virtual network control appliances such as the network control appliances 114. The network control appliances 114 can establish secure connections to each of the edge network devices 118 and distribute route and policy information via a control plane protocol (e.g., Overlay Management Protocol (OMP) (discussed in further detail below), Open Shortest Path First (OSPF), Intermediate System to Intermediate System (IS-IS), Border Gateway Protocol (BGP), Protocol-Independent Multicast (PIM), Internet Group Management Protocol (IGMP), Internet Control Message Protocol (ICMP), Address Resolution Protocol (ARP), Bidirectional Forwarding Detection (BFD), Link Aggregation Control Protocol (LACP), etc.). In some embodiments, the network control appliances 114 can operate as route reflectors. The network control appliances 114 can also orchestrate secure connectivity in the data plane 116 between and among the edge network devices 118. For example, in some embodiments, the network control appliances 114 can distribute crypto key information among the edge network devices 118. This can allow the network to support a secure network protocol or application (e.g., Internet Protocol Security (IPSec), Transport Layer Security (TLS), Secure Shell (SSH), etc.) without Internet Key Exchange (IKE) and enable scalability of the network. In some embodiments, physical or virtual Cisco® SD-WAN vSmart controllers can operate as the network control appliances 114.

The data plane 116 can be responsible for forwarding packets based on decisions from the control plane 112. The data plane 116 can include the edge network devices 118, which can be physical or virtual edge network devices. The edge network devices 118 can operate at the edges various network environments of an organization, such as in one or more data centers 126, campus networks 124, branch office networks 122, home office networks 120, and so forth, or in the cloud (e.g., Infrastructure as a Service (IaaS), Platform as a Service (PaaS), SaaS, and other cloud service provider networks). The edge network devices 118 can provide secure data plane connectivity among sites over one or more WAN transports, such the internet transport network 128 (e.g., Digital Subscriber Line (DSL), cable, etc.), MPLS networks 130 (or other private packet-switched network (e.g., Metro Ethernet, Frame Relay, Asynchronous Transfer Mode (ATM), etc.), mobile networks 132 (e.g., 3G, 4G/LTE, 5G, etc.), or other WAN technology (e.g., Synchronous Optical Networking (SONET), Synchronous Digital Hierarchy (SDH), Dense Wavelength Division Multiplexing (DWDM), or other fiber-optic technology; leased lines (e.g., T1/E1, T3/E3, etc.); Public Switched Telephone Network (PSTN), Integrated Services Digital Network (ISDN), or other private circuit-switched network; small aperture terminal (VSAT) or other satellite network; etc.). The edge network devices 118 can be responsible for traffic forwarding, security, encryption, quality of service (QoS), and routing (e.g., BGP, OSPF, etc.), among other tasks. In some embodiments, physical or virtual Cisco® SD-WAN vEdge routers can operate as the edge network devices 118.

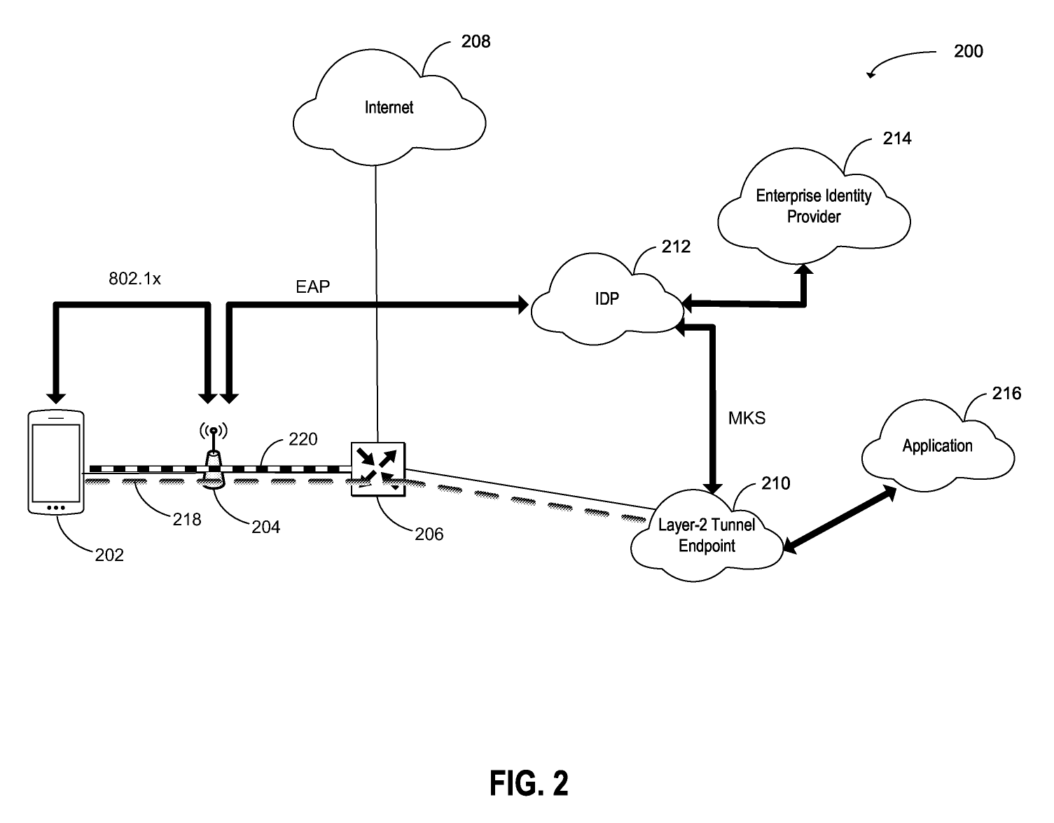

FIG. 2 illustrates an example network structure for performing L2 split tunneling according to some aspects of the present disclosure.

In example architecture 200 of FIG. 2, a user device 202 may be connected to a network (e.g., an enterprise network, a public Wi-Fi, and/or any other wireless network) via access point 204.

User device 202 may be any know or to be developed device capable of establishing a wired and/or wireless network connection to a network. Non-limiting examples of user device 202 may be a laptop, a mobile phone, a tablet, etc. Furthermore, while FIG. 2 illustrates one user device (user device 202) for illustration purposes, the present disclosure is not limited thereto and may include any number of user devices such as user device 202. Similarly, the number of access points is not limited to one as shown in FIG. 2 but may include more than one access point.

Architecture 200 may further include gateway 206 for routing network traffic towards internet 208 (for personal traffic) or towards L2 tunnel endpoint 210 (e.g., for encrypted, work-related traffic). An Identity Provider (IDP) such as IDP 212 may be a federation-based identify provider for authenticating work profile and/or personal profile of a user. Federation-based identity provider may enable authentication in the context of OpenRoaming access.

IDP 212 may perform such authentication in part by accessing enterprise identity store 214 for authenticating a user’s work profile. While IDP 212 is provided as one example implementation of Federation-base identity provider, the present disclosure is not limited thereto and any other known or to be developed enterprise identity and authorization service may be used.

Network traffic received at L2 tunnel endpoint 210 may be subject to known or to be developed packet processing (e.g., decapsulation, inspection, etc.) before being ultimately transmitted to the intended application such as application 216.

As will be described below, example embodiments of the present disclosure enable profile based separation of work-related and personal data traffic that are then transmitted to the appropriate destination using automated L2 tunneling. These separated traffics are shown as being sent via tunnel 218 (for work traffic) and tunnel 220 (for personal traffic), and will be further described below.

As noted above, user device 202 may be configured with multiple profiles. For instance, user device 202 may be configured with a personal profile and a work profile.

The personal profile may be used to access personal applications installed and available for use on user device 202. Non-limiting examples of personal applications include personal instant messaging applications (e.g., WhatsApp, Telegram, etc.), personal financial applications (e.g., credit card applications, bank and brokerage applications, etc.), personal streaming services (e.g., Netflix, Hulu, etc.), and/or otherwise any non-work related application installed and available for use on user device 202.

The work profile may be used to access work related applications installed and available for use on user device 202. Non-limiting examples of work-related applications include, work email, enterprise applications (e.g., applications for time entry, expense submission, VPN access, enterprise database applications such as Salesforce, etc.).

At any given time, data traffic may be initiated on user device 202 when any of the applications available thereon are used, be in personal applications or work-related applications. To distinguish personal and work-related applications, the operating system on user device 202 may apply labels to each profile. For some operating systems (e.g., Android), each profile is a container at or above the core operating system. Each application may make network socket calls from within its container, and the core operating system can then validate the socket call before transmitting it down the networking stack. Therefore, the core operating system has awareness of the profile from which the socket call emanates. For instance, application A may be installed only for one profile (work or personal), while application B may be installed for both profiles (and be installed twice, partially or entirely).

For some operating systems (e.g., Apple iOS), the profiles are applied at application level. Therefore, application A is installed on the operating system and available for all profiles. A user profile for work traffic may be activated for that application, and another user profile for personal traffic may also be activated. In this instance, when the application is opened, a user can select one of the profiles on user device 202 and access the profile-relevant content (e.g., list of personal or work emails in mailbox), and/or otherwise interact with the application from within the relevant profile. In this case, although the application is common to all profiles, the user actions are initiated from within a profile, and the application has awareness that a socket call has relevance for one or another profile.

In some examples, user device 202 may be configured with one or more enterprise 802.1x profiles with enterprise identities. Such profiles can enable both work and personal profiles of the user to be authenticated with 802.1x when user device 202 attaches to an enterprise network (e.g., when a user connects to the enterprise network at work using user device 202).

Furthermore, user device 202 may be configured with profiles with Federation-based (such as OpenRoaming) identities, that allows both work and personal profiles to be authenticated with 802.1x on federation-based Identity Providers (e.g., via IDP 212). This allows these profiles to be used across multiple Wi-Fi networks (roaming), and in some instances possibly simultaneously.

When a Wi-Fi network is in range of the user device 202, user device 202 may perform the necessary authentication using the work profile for both the work and the private profiles (e.g., when user device 202 connects to an enterprise network at work).

In another example, user device 202 may connect to a public Wi-Fi. In this instance, user device 202 may perform the necessary authentication for using work-related applications using the work profile and separately perform the necessary authentication for using personal applications using the personal profile. These authentications may typically be performed against a federation-based identity provider (e.g., using IDP 212 and enterprise identity store 214).

Regardless of the type of network that the user device 202 is attempting to connect (e.g., enterprise network or public Wi-Fi), user device 202 associates with (establishes a connection to) access point 204 using access point’s MAC address and may use the work profile first. While user device 202 uses the work profile first, user device 202 leverages a personal MAC access of user device 202. In one example, user device 202 may generate a personal MAC to use for the authentication. This MAC address may be generated according to any known or to be developed method.

The Access point may then perform the authentication (e.g., 802.1x authentication) against the work Identity Provider AAA server (e.g., IDP 212). The work Identity provider will authenticate the user against enterprise identity store 214. In some examples the authentication method used may be an Extensible Authentication Protocol (EAP) such as a tunneled EAP method. Non-limiting examples of tunneled EAP methods include EAP-Tunnel Transport Layer Security (EAP-TTLS), EAP-Flexible Authentication via Secure Tunneling (EAP-FAST) or EAP-Tunnel Extensible Authentication Protocol (EAP-TEAP).

Upon EAP Success, in an Access Accept message, inside the TLS tunnel (inner attributes) that is set up as part of the EAP exchange, IDP 212 may include a MAC address of a cloud tunnel endpoint. This attribute may then be tunneled all the way to user device 202 as part of the EAP Exchange.

In the Access Accept message, outside the TLS tunnel (outer attributes), IDP 212 may include the MAC address of the cloud tunnel endpoint as well as the IP address of a Fully Qualified Domain Name (FQDN) of the tunnel endpoint. These attributes may then be sent to access point 204.

In another example, IDP 212 may additionally send a Master Session Key that IDP 212 calculated and returns the same in EAP Success to L2 tunnel endpoint 210.

In one example, when user device 202 receives the EAP success, user device 202 may calculate a Pairwise Master Key (PMK) and perform a 4-way handshake and complete association with access point 204, and receive an IP address in the personal context from access point 204.

In another example, when user device 202 receives the EAP Success, user device 202 will disassociate from access point 204, and re-associate with access point 204 using the personal MAC address that user device 202 generated, performing EAP authentication with the personal profile, and completing association and receiving an access point IP address in the personal context from access point 204. In this instance, user device 202 also generates a work association with the MAC address returned from IDP 212 inside the EAP tunnel. In response, access point 204 may respond to the association request using the MAC address, as access point 204 has received the MAC address from IDP 212 in the outer attributes in the Access Accept message.

Access point 204 may then encapsulate the 802.11 frame in a L2 tunneling protocol such as Control and Provisioning of Wireless Access Points (CAPWAP), Lightweight Access Point Protocol (LWAPP) or Generic Routing Encapsulation (GRE) and forward it to L2 tunnel endpoint 210 returned in the outer attributes of the Access Accept message.

Because L2 tunnel endpoint 210 already received the MSK from IDP 212, user device 202 can calculate PMK and perform a 4-way handshake and complete association with access point 204, and receive an IP address in the work context from L2 tunnel endpoint 210.

At this point, user device 202 can map all personal traffic on the personal 802.11 association (e.g., using tunnel 220) and all work traffic to the work 802.11 association (e.g., using tunnel 218). This will result in the personal traffic being sent directly to internet 208 by access point 204 (via gateway 206), and the work traffic being tunneled to L2 tunnel endpoint 210 for further processing by enterprise security services such as SASE services, packet decapsulation and/or inspection, etc.

Additionally, user device 202 and access point 204 can leverage different Quality of Service (QoS) marking on personal vs work associations in order to further differentiate treatment of work applications and personal applications, as appropriate.

The process described above, enables assignment of two different IP addresses for user device 202 to use with the personal IP address being used to send personal traffic to internet 208 and work IP address being used to send enterprise traffic to L2 tunnel endpoint 210.

The above process has been described with an example scenario of a device having a single personal profile and a single work profile. However, the present disclosure is not limited thereto and a user device such as user device 202 may have more than two personal profiles and/or more than two work profiles configured thereon.

Moreover, aspects of the present disclosure encompass establishing more than one L2 tunnel endpoint for user device 202. For instance, one work IP address may be generated and assigned to user device 202, per the process described above, to send relevant network traffic to an enterprise edge (not shown in FIG. 2) for applications accessible at the network edge, while another work IP address may be used to send traffic to enterprise applications stored cloud.

In examples described above reference has been made to work profiles, work IP address, and work-related traffic. Terms work and enterprise may be used interchangeably throughout the present disclosure. Hence a work profile may also be referred to as an enterprise profile, work IP address may be referred to as an enterprise IP address, work-related traffic may be referred to as enterprise-related traffic or simply enterprise traffic, and so on.

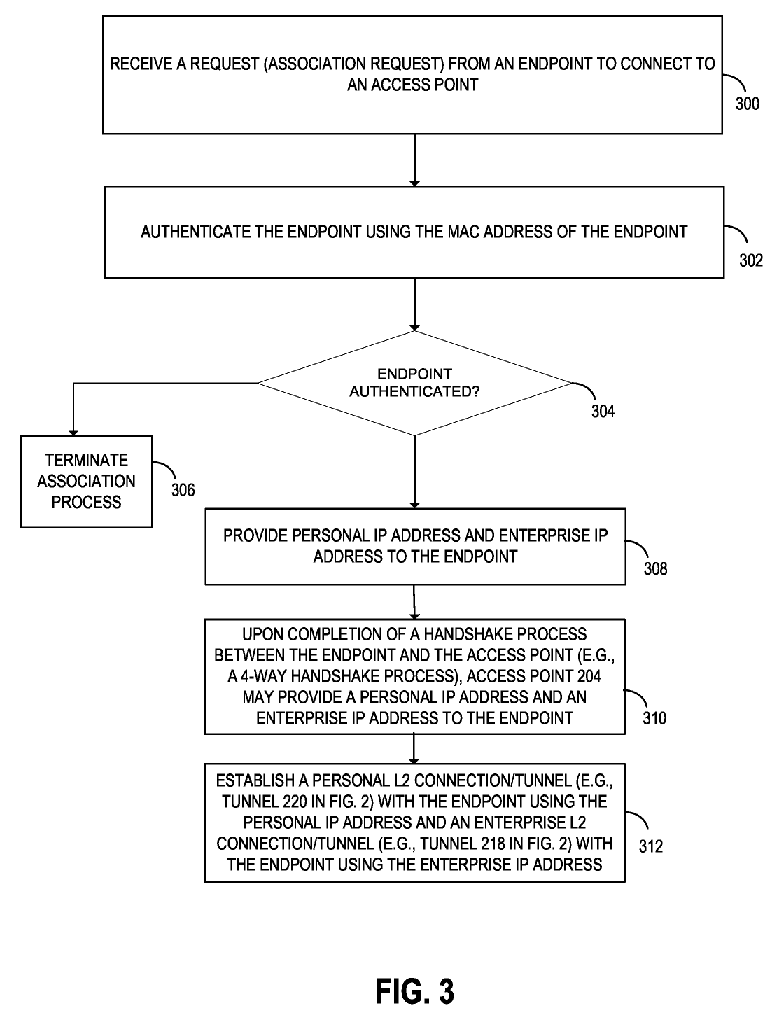

FIG. 3 illustrates a method for performing Layer-2 split tunneling according to some aspects of the present disclosure. Example process of FIG. 3 may be performed from the perspective of access point 204. In doing so, access point 204 may have one or more memories having computer-readable instructions stored therein. Access point 204 may further have one or more processors configured to execute the computer-readable instructions stored in the one or more memories to perform steps of FIG. 3 described below. While FIG. 3 is described from the perspective of access point 204, the present disclosure is not limited thereto. One or more steps thereof may be performed by one or more other components of architecture 200 of FIG. 2 and/or one or more components described with reference to network architecture 100 of FIG. 1.

At step 300, access point 204 may receive a request from an endpoint to connect to (associate with) the access point, wherein the endpoint is configured with at least one personal profile and one enterprise profile. The endpoint may be the same as user device 202 references above. In one example personal profile and the enterprise profile may be 802.1x profiles.

The request may be received when the endpoint attempts to connect to a network, which as described above may be an enterprise network, a public Wi-Fi, etc.

At step 302, access point 204 may authenticate the endpoint using a first MAC address of the endpoint. In one example, access point 204 authenticates the endpoint using the enterprise profile against an enterprise identity and authorization service (e.g., IDP 212). However, as noted above, separate authentications may be performed using the enterprise profile and personal profile.

In one example, the endpoint generates the first MAC address, and the MAC address is a personal MAC address of the endpoint.

As described with reference to FIG. 2, the authenticating at step 302 may be performed using an Extensible Authentication Protocol (EAP) method. In one example, the EAP method is a tunneled EAP method. In one example, the tunneled EAP method may be any one or more of an EAP-TTLS method, an EAP-FAST method, and an EAP-TEAP method. However, the present disclosure is not limited to these authentication methods and may include any other known or to be developed authentication method.

As noted above, the authentication may be performed against an enterprise identify and authorization service such as an IDP AAA.

At step 304, a determination is made as to whether the authentication has been successful or not. If not, the process proceeds to step 306 where the endpoint’s association process is terminated. If successful, the process proceeds to step 308.

At step 308, and as part of a message indicating successful authentication of the enterprise profile, access point 204 may receive at least a second MAC address of a tunnel endpoint (L2 tunnel endpoint 210) and an IP address of a domain name of the tunnel endpoint.

In one example, when authentication is performed using an EAP method, the message is an EAP success message. The EAP success message may include the second MAC address. The second MAC address may be included inside a TLS tunnel of the EAP success message to be passed directly to the endpoint as described above. The second MAC address may also be included outside a TLS tunnel of the EAP success message along with the IP address of the domain name.

As described above with reference to FIG. 2, as part of the authentication process, IDP 212 may generate and transmit a Master Session Key to the tunnel endpoint, which as will be described below may be used for passing the enterprise IP address of L2 tunnel endpoint 210 to the endpoint.

At step 310, upon completion of a handshake process between the endpoint and the access point (e.g., a 4-way handshake process), access point 204 may provide a personal IP address and an enterprise IP address to the endpoint, the enterprise IP address being the IP address of the domain name of the tunnel endpoint (IP address of the FQDN described above with reference to FIG. 2).

In one example, providing the personal IP address may be as follows. When the endpoint receives the EAP success message, the endpoint determines the PMK and perform a 4-way handshake with access point 204 to complete association with access point 204. Once associated, the endpoint receives the personal IP from access point 204.

In another example, when the endpoint receives the EAP success message, access point 204 receives an indication from the endpoint that the endpoint has disassociated with the access point. Access point 204 then receives a re-association request from the endpoint with the first MAC address (personal MAC address of the endpoint) after it disassociated with the access point. Access point 204 completes the re-association process using the first MAC address (e.g., performs EAP authentication with the personal profile). Once completed, the endpoint receives the personal IP from access point 204.

At step 310, access point 204 also provides an enterprise IP address to the endpoint. This process may be as follows. Access point 204 may receive an association request based on the second MAC address, wherein the second MAC address is provided to the endpoint as part of the message (e.g., returned from IDP 212 inside the EAP TLS tunnel as described above).

Then, access point 204 sends the request encapsulated an L2 tunneling protocol to the tunnel endpoint. More specifically, access point 204 encapsulates the 802.11 frame in an L2 tunneling protocol such as CAPWAP, LWAPP or GRE and forward the same to L2 tunnel endpoint 210 (e.g., returned in the outer attributes of the Access accept message).

Thereafter, upon a successful completion of a handshake between access point 204 and the endpoint, access point 204 may receive the enterprise IP address from L2 tunnel endpoint 210 and provide the same to the endpoint. Because the L2 tunnel endpoint already received the MSK from IDP 212, the endpoint can determine the PMK and perform a 4-way handshake with access point 204 and complete the association with access point 204. In response, the endpoint may receive the enterprise IP address from L2 tunnel endpoint 210.

At step 312, having both the personal and enterprise IP addresses, access point 204 can establish a personal L2 connection/tunnel (e.g., tunnel 220 in FIG. 2) with the endpoint using the personal IP address and an enterprise L2 connection/tunnel (e.g., tunnel 218 in FIG. 2) with the endpoint using the enterprise IP address. Then, access point 204 may can send personal traffic received over the personal L2 connection directly to internet 208 and send enterprise network traffic received over the enterprise L2 connection to L2 tunnel endpoint 210.

With separate IP address and separate L2 tunnels established for the endpoint (e.g., user device 202), both profiles may be used simultaneously and associated traffic may be separated and transmitted over their respective L2 tunnel.

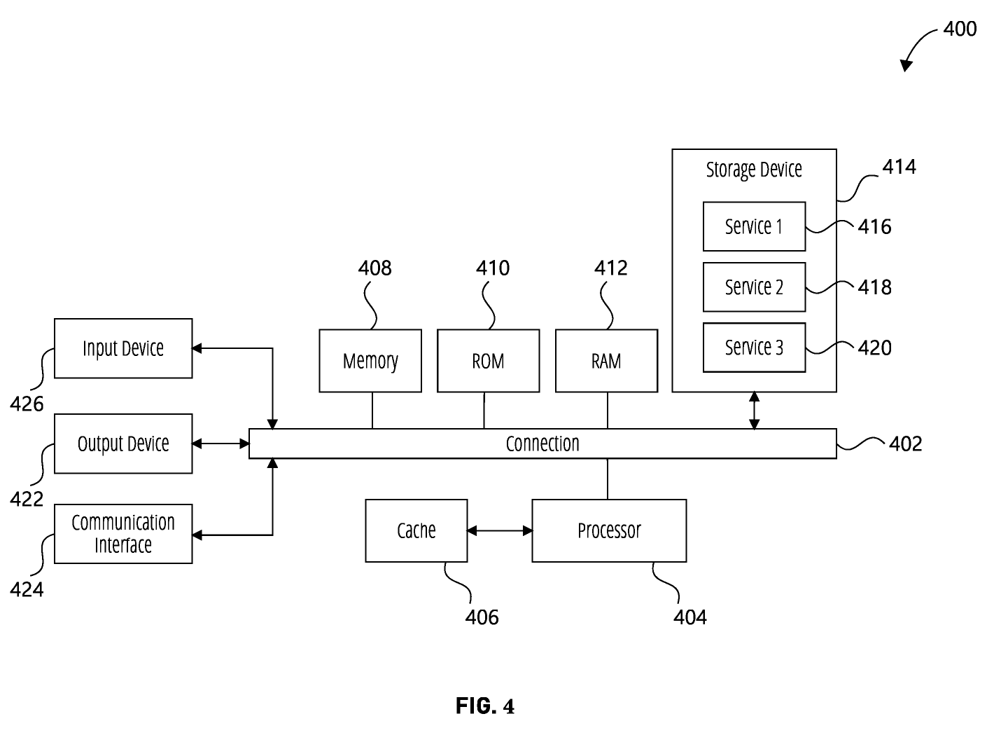

FIG. 4 shows an example of computing system 400, which can be for example any computing device making up user device 202, access point 204, and/or any other component shown in network architecture 100 of FIG. 1 and/or architecture 200 of FIG. 2. As shown, components of computing system 400 may be in communication with each other using connection 402. Connection 402 can be a physical connection via a bus, or a direct connection into processor 404, such as in a chipset architecture. Connection 402 can also be a virtual connection, networked connection, or logical connection.

In some embodiments, computing system 400 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 400 includes at least one processing unit (e.g., CPU or processor 404) and connection 402 that couples various system components including system memory 408, such as read-only memory (e.g., ROM 410) and random access memory (e.g., RAM 412) to processor 404. Computing system 400 can include a cache of high-speed memory 406 connected directly with, in close proximity to, or integrated as part of processor 404.

Processor 404 can include any general purpose processor and a hardware service or software service, such as services 416, 418, and 420 stored in storage device 414, configured to control processor 404 as well as a special-purpose processor where software instructions are incorporated into the actual processor design. Processor 404 may essentially be a completely self-contained computing system, containing multiple cores or processors, a bus, memory controller, cache, etc. A multi-core processor may be symmetric or asymmetric.

To enable user interaction, computing system 400 includes an input device 426, which can represent any number of input mechanisms, such as a microphone for speech, a touch-sensitive screen for gesture or graphical input, keyboard, mouse, motion input, speech, etc. Computing system 400 can also include output device 422, which can be one or more of a number of output mechanisms known to those of skill in the art. In some instances, multimodal systems can enable a user to provide multiple types of input/output to communicate with computing system 400. Computing system 400 can include communication interface 424, which can generally govern and manage the user input and system output. There is no restriction on operating on any particular hardware arrangement, and therefore the basic features here may easily be substituted for improved hardware or firmware arrangements as they are developed.

Storage device 414 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 414 can include software services, servers, services, etc., that when the code that defines such software is executed by the processor 404, it causes the system to perform a function. In some embodiments, a hardware service that performs a particular function can include the software component stored in a computer-readable medium in connection with the necessary hardware components, such as processor 404, connection 402, output device 422, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A method comprising:
receiving, at an access point, a request from an endpoint to connect to the access point, wherein the endpoint is configured with at least a personal profile and an enterprise profile;
authenticating the endpoint in association with the enterprise profile, using a first MAC address of the endpoint and against an enterprise identity and authorization service;
receiving, as part of a message indicating successful authentication of the enterprise profile, at least a second MAC address of a tunnel endpoint and an IP address of a domain name of the tunnel endpoint; and
upon completion of a handshake process between the endpoint and the access point, providing a personal IP address and an enterprise IP address to the endpoint, the enterprise IP address being the IP address of the domain name of the tunnel endpoint,
wherein the access point establishes a personal L2 connection with the endpoint using the personal IP address and an enterprise L2 connection with the endpoint using the enterprise IP address, wherein the access point transmits personal traffic received over the personal L2 connection directly to internet and forwards enterprise network traffic received over the enterprise L2 connection to the tunnel endpoint.

2. The method of claim 1, wherein the endpoint generates the first MAC address, and the first MAC address is a personal MAC address of the endpoint.

3. The method of claim 1, wherein the access point authenticates the endpoint using a tunneled Extensible Authentication Protocol method.

4. The method of claim 1, wherein the message is an Extensible Authentication Protocol success message and the second MAC address is included inside a TLS tunnel of the Extensible Authentication Protocol success message and is included outside the TLS tunnel of the Extensible Authentication Protocol success message along with the IP address of the tunnel endpoint.

5. The method of claim 1, wherein providing the personal IP address comprises:
receiving an indication from the endpoint that the endpoint has disassociated with the access point;
receiving a request for a re-association from the endpoint with the first MAC address after it disassociated with the access point;
completing the re-association using the first MAC address; and
assigning the personal IP address to the endpoint after completing the re-association.

6. The method of claim 1, wherein providing the enterprise IP address comprises:
receiving an association request based on the second MAC address, wherein the second MAC address is provided to the endpoint as part of the message;
sending the request encapsulated an L2 tunneling protocol to the tunnel endpoint; and
upon a successful completion of a handshake between the endpoint and the tunnel endpoint, receiving the enterprise IP address from the tunnel endpoint to be provided to the endpoint.

7. The method of claim 1, wherein,
the message includes at least a third MAC address of a second tunnel endpoint and a second IP address of a second domain name for the second tunnel endpoint; and
the access point establishes a second enterprise L2 connection, wherein at least a portion of the enterprise network traffic is sent over the enterprise L2 connection and another portion of the enterprise network traffic is sent over the second enterprise L2 connection.

8. An access point comprising:
one or more memories having computer-readable instructions stored therein; and
one or more processors configured to execute the computer-readable instructions to:
receive a request from an endpoint to connect to the access point, wherein the endpoint is configured with at least a personal profile and an enterprise profile;
authenticate the endpoint in association with the enterprise profile, using a first MAC address of the endpoint and against an enterprise identity and authorization service;
receive, as part of a message indicating successful authentication of the enterprise profile, at least a second MAC address of a tunnel endpoint and an IP address of a domain name of the tunnel endpoint; and
upon completion of a handshake process between the endpoint and the access point, provide a personal IP address and an enterprise IP address to the endpoint, the enterprise IP address being the IP address of the domain name of the tunnel endpoint,
wherein the access point establishes a personal L2 connection with the endpoint using the personal IP address and an enterprise L2 connection with the endpoint using the enterprise IP address, wherein the access point transmits personal traffic received over the personal L2 connection directly to internet and forwards enterprise network traffic received over the enterprise L2 connection to the tunnel endpoint.

9. The access point of claim 8, wherein the endpoint is configured to generate the first MAC address, and the first MAC address is a personal MAC address of the endpoint.

10. The access point of claim 8, wherein the access point is configured to authenticate the endpoint using a tunneled Extensible Authentication Protocol method.

11. The access point of claim 8, wherein the message is an Extensible Authentication Protocol success message and the second MAC address is included inside a TLS tunnel of the Extensible Authentication Protocol success message and is included outside the TLS tunnel of the Extensible Authentication Protocol success message along with the IP address of the tunnel endpoint.

12. The access point of claim 8, wherein the one or more processors are configured to execute the computer-readable instructions to provide the personal IP address by:
receiving an indication from the endpoint that the endpoint has disassociated with the access point;
receiving a request for a re-association from the endpoint with the first MAC address after it disassociated with the access point;
completing the re-association using the first MAC address; and
assigning the personal IP address to the endpoint after completing the re-association.

13. The access point of claim 8, wherein the one or more processors are configured to execute the computer-readable instructions to provide the enterprise IP address by:
receiving an association request based on the second MAC address, wherein the second MAC address is provided to the endpoint as part of the message;
sending the request encapsulated an L2 tunneling protocol to the tunnel endpoint; and
upon a successful completion of a handshake between the endpoint and the tunnel endpoint, receiving the enterprise IP address from the tunnel endpoint to be provided to the endpoint.

14. The access point of claim 8, wherein,
the message includes at least a third MAC address of a second tunnel endpoint and a second IP address of a second domain name for the second tunnel endpoint; and
the access point is configured to establish a second enterprise L2 connection, wherein at least a portion of the enterprise network traffic is sent over the enterprise L2 connection and another portion of the enterprise network traffic is sent over the second enterprise L2 connection.

15. One or more non-transitory computer-readable media comprising computer-readable instructions, which when executed by one or more processors of an access point, cause the access point to:
receive a request from an endpoint to connect to the access point, wherein the endpoint is configured with at least a personal profile and an enterprise profile;
authenticate the endpoint in association with the enterprise profile, using a first MAC address of the endpoint and against an enterprise identity and authorization service;
receive, as part of a message indicating successful authentication of the enterprise profile, at least a second MAC address of a tunnel endpoint and an IP address of a domain name of the tunnel endpoint; and
upon completion of a handshake process between the endpoint and the access point, provide a personal IP address and an enterprise IP address to the endpoint, the enterprise IP address being the IP address of the domain name of the tunnel endpoint,
wherein the access point establishes a personal L2 connection with the endpoint using the personal IP address and an enterprise L2 connection with the endpoint using the enterprise IP address, wherein the access point transmits personal traffic received over the personal L2 connection directly to internet and forwards enterprise network traffic received over the enterprise L2 connection to the tunnel endpoint.

16. The one or more non-transitory computer-readable media of claim 15, wherein the endpoint is configured to generate the first MAC address, and the first MAC address is a personal MAC address of the endpoint.

17. The one or more non-transitory computer-readable media of claim 15, wherein the access point is configured to authenticate the endpoint using a tunneled Extensible Authentication Protocol method.

18. The one or more non-transitory computer-readable media of claim 15, wherein the message is an Extensible Authentication Protocol success message and the second MAC address is included inside a TLS tunnel of the Extensible Authentication Protocol success message and is included outside the TLS tunnel of the Extensible Authentication Protocol success message along with the IP address of the tunnel endpoint.

19. The one or more non-transitory computer-readable media of claim 15, wherein execution of the computer-readable instructions by the one or more processors cause the access point to provide the personal IP address by:
receiving an indication from the endpoint that the endpoint has disassociated with the access point;
receiving a request for a re-association from the endpoint with the first MAC address after it disassociated with the access point;
completing the re-association using the first MAC address; and
assigning the personal IP address to the endpoint after completing the re-association.

20. The one or more non-transitory computer-readable media of claim 15, wherein execution of the computer-readable instructions by the one or more processors cause the access point to provide the enterprise IP address by:
receiving an association request based on the second MAC address, wherein the second MAC address is provided to the endpoint as part of the message;
sending the request encapsulated an L2 tunneling protocol to the tunnel endpoint; and
upon a successful completion of a handshake between the endpoint and the tunnel endpoint, receiving the enterprise IP address from the tunnel endpoint to be provided to the endpoint.
